(19) United States
(12) Patent Application Publication
(10) Pub. No.: US 2026/0069496 A1
(43) Pub. Date: Mar. 12, 2026

(54) Elliptical Massage Gun Having Attachments

(71) Applicant: Charles M. Curley, Cortland, NY (US)

(72) Inventor: Charles M. Curley, Cortland, NY (US)

(21) Appl. No.: 19/390,794

(22) Filed: Nov. 17, 2025

Related U.S. Application Data
(63) Continuation-in-part of application No. 19/231,499, filed on Jun. 8, 2025, now Pat. No. 12,508,201.
(63) Continuation-in-part of application No. 17/488,831, filed on Sep. 29, 2021, now Pat. No. 12,350,222.

(51) Int. Cl. A61H 23/02; A61H 23/00; A61H 23/04

(52) U.S. Cl. CPC A61H 23/0254; A61H 23/006; A61H 23/04; A61H 2201/0153; A61H 2201/1666

(57) ABSTRACT

A handheld motorized massage gun is disclosed that combines the percussive action of conventional percussive-type massage guns with muscle stretching and kneading action of rolling element massage devices. The self-powered device is compatible with a plurality of removably coupled attachments which make oscillating contact with a fascia surface. Each of the orbiting attachments orbits along a circular path about a virtual axis while inducing both percussive forces and stretching forces along the axis of the target fascia. Each attachment induces a different affect upon the fascia surface for the purpose of treating cellulite and/or providing muscle rehabilitation. The resulting massage motions and affects are not achievable with the attachments of conventional massage guns having fixed-axis pistons.

### FIELD OF THE INVENTION

This invention relates to the field of massage devices that utilize percussive motion or rolling motion to simulate the manual therapeutic massage techniques that are historically utilized by massage therapists.

### BACKGROUND OF THE INVENTION

There exist many massage therapies and massage devices which have been designed to rehabilitate muscle fiber or treat cellulite by rubbing, twisting, beating, stretching, compressing and rolling the upper superficial fatty layer and muscle layers that reside immediately underneath the skin. Three of the most common massage techniques used by massage therapists are called Myofascial Release, Tapotement and Petrissage. While these are techniques utilized manually by massage therapists, mechanized devices have been developed to simulate each of these techniques, thus alleviating the tiring manual tasks utilized by human massage therapists.

One simple type of massage therapy device simulates a technique called myofascial release, which is a form of soft tissue therapy intended to increase blood circulation, decompose fat cells, stretch muscles and relieve pain. Tightened muscle and tissue fibers are called “myofascial restrictions”. Myofascial release therapy stretches and compresses the fascia to alleviate the restrictions, decompose fat cells and make the tissue fiber more flexible. FIG. 1 illustrates the reciprocating motion of the therapist's hands while performing this type of massage. The fascial region between the two hands is compressed as the hands move together, and then stretched as the hands move apart, such that the massage-receiving region is cyclically compressed and stretched to relieve the restrictions.

Massage devices that simulate the Myofascial Release technique typically utilize balls or rollers that are traversed over the fascia regions to release the restrictions. FIG. 2 is reproduced from prior art U.S. Pat. No. 7,169,120 and illustrates a very simple massage device that utilizes a revolving ball to simulate myofascial release massage. This is called a “passive” massage device because the reciprocating motion is provided by the user, who grasps the device 1090 by handle 1098 and drags the device along the massage-receiving surface with a reciprocating motion. As shown in FIG. 3, the ball 1096 produces a traveling compressive wave along the fascia in front of its path as it is pushed along the surface by the user. The rotation of the ball allows the wave to be created without uncomfortable frictional drag along the fascia surface. The compressive wave region of the fascia is compressed, while the region of fascia that trails the ball is stretched. As the user reciprocates the ball along the massage-receiving surface, the fascial regions surrounding the ball experience alternating modes of compression and stretching as the traversing direction is changed.

Another myofascial massage device is taught by prior art US Patent application US2008/0058687 A1, which is a non-motorized massage device which utilizes multiple rollers. FIG. 4 is an illustration of that device as reproduced from that disclosure and explains two pairs of rollers that rotate upon skewed axles as a user traverses the device along a targeted fascia. The user's reciprocating motion alternately compresses and stretches the fascia region between the two pairs of rollers, producing myofascial massage along the elongate axis of the muscle fibers which are oriented with their elongate axis parallel to the axis of the limb. The disclosure's author claims that the device is advantageous in comparison to conventional massage gun devices, explaining;
The conventional massager does not exercise the body muscle because muscle toning needs to pull and contract muscle (US2008/0058687 A1 @ [0002])

A second massage technique that is said to relax muscles and treat cellulite is called Tapotement, which is merely the rapid and repeated striking of the fascia. This technique is commonly known as “percussive massage” in laymen's terms. Tapotement massage techniques are techniques that are used by therapists upon body fascia that involve percussion movements, such as tapping, thumping, pounding, cupping and similar strikes. FIG. 5 illustrates the hand movement of a massage therapist when performing one exemplary type of percussive massage. In this illustration, the fingers are extended. In other percussive massage variations, the fingers are folded inward to form a fist.

Mechanical devices that simulate percussive massage are commonly called “massage guns” or “fascia guns”. These devices use a reciprocating fixed-axis piston to impart percussive forces against target areas of the fascia and are said to be effective for treatment of the deeper fascia and muscle tissue. Many such devices have been patented and commercialized, and some have been marketed as “Anti-Cellulite Massagers”. An example of a battery powered percussive massage gun configuration is shown in the illustration of FIG. 6 which is similar to the configurations described in a myriad of prior art design patents and utility patents.

Referring to FIG. 6, a massage gun 900 has a percussive massage head 905 with a spherically crowned shape which is mounted on the end of a fixed-axis piston 906 that reciprocates in the direction of the axis of the arrow 904 within the housing 902 to create a reciprocating linear movement of the head 905. The main housing 901 has a cylindrical extension 903 which houses a battery-driven motor. As exemplified in many prior art devices, the cylindrical battery assembly 918 has the dual functions of housing the battery and also acting as the handle for the massage gun 900. The user grips the cylindrical extension 918 in a way similar to grasping a pistol and then presses the massage head 905 against the target muscle or tissue of the human body. The reciprocating head motion is initiated by engaging an “ON” switch. This type of massage device produces only up and down reciprocating motion of the massage head 905 perpendicular to the fascia surface. Additionally, the person holding these devices experiences a “reactionary bounce” which causes difficulty in holding the device steady over a chosen muscle target.

FIG. 7 illustrates a massage gun having a focusing rest 1210 as taught by U.S. Pat. No. 12,350,222. A focusing rest is used to anchor the massage gun in a steadied position upon the fascia surface while focusing treatment upon a specific muscle. Rollers are adapted to this device to make the massage device easily traversable with a reciprocating motion along the fascia surface in a self-standing attitude. The device may be traversed along the massage-receiving surface in the direction shown by arrow 1244. The device possesses two stabilizing rollers 1220 and 1230 which freely rotate upon axle 1211. A third roller 1224 is mounted on a motor-driven piston that pulsates bidirectionally with linear reciprocating motion along a single vector indicated by arrow 1248. The roller 1224 also rotates freely upon axle 1240 as the user traverses the assembly 1200 along the massage-receiving surface. The axles 1240 and 1211 are fixed to the device in a direction that is orthogonal to the direction 1244.

The stabilizing rollers 1220 and 1230 act to relieve the “reactionary bounce” problem encountered by the user in holding a conventional massage gun steady. However, none of the rollers 1220, 1230, or 1224 induce opposing forces in a direction parallel to the massage-receiving surface to stretch and compress the fascia. While relieving the stability problem, the device in FIG. 7 can nevertheless only produce percussive forces perpendicular to the fascia surface. None of the prior art devices referenced above allow the simultaneous motor-driven application of Myofascial Release and Tapotement when the device is held steady at a position which is targeting treatment upon one specific fascia region.

A third common massage technique is illustrated in FIG. 8 and is formally called “Petrissage”. This is a technique commonly used by therapists to treat cellulite by “skin rolling” and “kneading” the fat deposits that are trapped in pockets of the upper epidermis region. Skin rolling is a technique whereby the therapist pinches the fascia and rolls the pinched region along the surface. Kneading is the process of repetitiously pinching and then releasing the skin fold.

There exist many patents of mechanized devices that simulate petrissage (skin rolling and kneading) techniques, and many of them use vacuum to create the skin fold by raising a small section of fascia above the surrounding fascia surface. Prior art U.S. Pat. No. 5,665,053 teaches a vacuum device which utilizes a vacuum pump and two rollers to perform Petrissage massage.

FIG. 9 is reproduced from that patent and illustrates the affect of the vacuum 1325 in creating a skin roll. This is a passive device 1310 that is dragged along the massage-receiving surface by the user as the vacuum source is applied to the chamber 1324. As the skin roll is raised by the vacuum, the two rollers 1326A and 1326B are mounted in slots which allow the vacuum to pull them closer together, thus assisting in holding the skin roll in the elevated position. The two rollers 1323 and 1327 roll in the same direction as the user moves the device in the direction shown. This patent explains that the skin roll consists of four layers including the skin 1312, the superficial fatty layer 1314, the fascia superficialous 1316, and the deep fatty layer 1318. The device is incapable of producing the reciprocating compression and stretching cycle that is induced by the myofascial release technique. Nor can the device produce the percussive massage forces that are produced by conventional fixed-axis piston-driven massage guns.

Massage guns have historically utilized exchangeable attachments to produce different massage affects upon the fascia surface. FIG. 10 is excerpted from U.S. Pat. No. 6,805,700 (2004) which is entitled “Percussive Therapeutic Device”. The figure shows a massage gun and a plurality of attachments which the inventor describes as “multiple impact heads” 64 which are attached to the device by a “coupler” 65. Each of the multiple impact heads can be removably coupled to the host device 72. The coupler is comprised of multiple pins that engage with multiple pin sockets 68 on the plurality of impact heads 70. In this way, all of the multiple impact heads utilize a common coupling mechanism, and are thus easily exchangeable.
One end of reciprocating rod extends from the housing and on the extended end is an impact head with a coupler for the mounting of one or more impact heads. ('700 1:39-42)

Coupling mechanisms are found in multiple arts where a plurality of attachments are exchangeably received by a single host device, such as in vacuum cleaner attachments, kitchen appliance attachments, socket wrenches, camera lenses and power tools. FIG. 11A illustrates a figure from a 1925 patent (US 1,775,402) which teaches a socket wrench having a spring-loaded ball which is commonly known as a “ball detent” coupler. Referring to FIG. 11A, the ball 22 is spring-loaded within the extension 19 of the socket wrench 18. This 100-year-old patent teaches that the ball 22 engages with a mating recess within the female socket 30.

FIG. 11B is excerpted from another early patent which taught a square extension 230 having two embedded spring-loaded balls 231 which are axially aligned and oppose each other. FIG. 11B is reproduced from U.S. Pat. No. 1,722,723 (1926) which was entitled “Jack Handle and Tire Lug Wrench”. This type of ball detent coupler is still used today in socket wrenches, power tool attachments and kitchen appliance attachments. It is also found in the massage gun art as a coupling device for receiving massage gun attachments.

Another commonly utilized coupler mechanism is called a “bayonet mount” and was taught by U.S. Pat. No. 2,736,871 (June 1952). A figure from that patent is reproduced in FIG. 12 herein.

Referring to FIG. 12, it can be seen that this type of coupler is sometimes also called a “twist lock” coupler, wherein the cam pin 62 follows a cam surface 60 as the female section 41 is twisted. Bayonet couplers are commonly utilized today for mounting camera lenses, vacuum cleaner attachments, power tool attachments and electrical connectors.

### SUMMARY OF THE PRESENT INVENTION

The handheld self-powered percussive massage gun being disclosed herein is designed to provide massage by collectively automating the three types of massage techniques which are normally utilized by massage therapists, including Myofascial Release, Tapotement (percussive massage) and Petrissage. These three massage techniques have been described in the prior art to treat cellulite (decompose fat cells), increase blood flow, decrease muscle stiffness, repair muscle tissue, reduce joint inflammation, for pain relief, and for increasing the flexibility of the fascial layers.

The Elliptical Massage Gun comprises a handheld, portable massage device having a plurality of removably coupled orbiting attachments which produce multiple massage affects upon the fascia surface by reciprocating along circular paths. These attachments produce unique massage force and motion patterns upon the fascia surface which were heretofore not possible with conventional massage guns having fixed-axis pistons. The attachments orbit circularly about a virtual axis while inducing massage forces in directions along the surface of the fascia and also in directions perpendicular to the fascia surface, such that the device simultaneously combines the advantages of Myofascial Release, Tapotement (percussive massage) and Petrissage.

The handheld device is completely portable and light weight, being powered by a small DC motor which receives its power from onboard rechargeable batteries and cooperates with onboard activation control. Treatments with this device do not require skin lubricants and can be made by the user in their own home or in the gym using one hand without reliance upon a massage therapist. The configuration and operation of the device will be better understood from the illustrated figures and descriptions that follow.

### BRIEF DESCRIPTION OF THE DRAWINGS

FIG. 1 is an illustration of the hand movement utilized by a massage therapist while implementing the Myofascial Release technique.

FIG. 2 is an illustration of a prior art device which is utilized to implement the Myofascial Release technique.

FIG. 3 is an illustration of the operation of the massage device described in FIG. 2

FIG. 4 is an isometric view of another prior art massage device which is utilized to implement the Myofascial Release technique.

FIG. 5 is an illustration of a hand movement utilized by a massage therapist while implementing the Tapotement (percussive massage) technique.

FIG. 6 is an illustration of a prior art percussive massage gun which is utilized to implement percussive massage.

FIG. 7 is an isometric view of a prior art massage device that is utilized for stabilizing a percussive massage gun while applying percussive massage in a traversing mode.

FIG. 8 is an illustration of a hand movement utilized by a massage therapist while implementing the Petrissage (“skin rolling” and “kneading”) technique.

FIG. 9 is an illustration of a prior art massage device that is utilized for implementing “skin rolling”and “kneading”.

FIG. 10 is an illustration of a prior art percussive device that utilizes exchangeable attachments which are removably coupled to the host device.

FIG. 11A is a reproduction from a prior art patent which taught a “ball detent” coupling device.

FIG. 11B is a reproduction from another prior art patent which taught a “ball detent” coupling device.

FIG. 12 is a is a reproduction from a prior art patent which taught a “bayonet mount” coupling device.

FIG. 13 is an isometric view of the Elliptical Massage Gun 100 being described herein.

FIG. 14 is a side elevational section view of the device 100.

FIGS. 15A, 15B and 15C are explanatory views of the piston drive mechanism of device 100 when isolated from the housing.

FIGS. 16A and 16B illustrate the piston drive mechanism in two successive positions while diagrammatically explaining the orbitally reciprocating piston motion.

FIG. 17 is an isometric view of the piston drive mechanism having an attachment removably coupled to the piston by a “ball detent” coupler.

FIG. 18 is an isometric view of the piston drive mechanism having an attachment removably coupled to the piston by a “bayonet mount” coupler.

FIG. 19A is anisometric view of one embodiment of a piston coupler being used for the attachments described herein.

FIG. 19B is an end view of the piston coupler shown in FIG. 19A.

FIG. 19C is anisometric view of another embodiment of a piston coupler being used for the attachments described herein.

FIG. 20A is an isometric view of the Elliptical Massage Gun 100 which illustrates the circular path of the second distal end of the piston.

FIG. 20B is an enlarged view of the piston movement of FIG. 20A showing its virtual axis.

FIG. 20C is a view of the piston movement of FIG. 20A showing its elliptical path and virtual axis.

FIGS. 21A and 21B are views which show the compressive fascia wave that is formed in each direction along the fascia surface at two extreme positions of the first orbiting attachment.

FIG. 22A through 22E are views which show the affect upon the fascia by the first orbiting attachment as the piston moves from its 12 o'clock to 3 o'clock to 6 o'clock to 9 o'clock, and to its 12 o'clock position.

FIG. 23A is an isometric view showing the second orbiting attachment coupled to the Elliptical Massage Gun 100.

FIG. 23B is an enlarged view of the second orbiting attachment.

FIG. 24A is a diagram showing the circular path of the axle of the second orbiting attachment.

FIG. 24B is a diagram showing the circular path of the axle of the second orbiting attachment and its virtual axis.

FIG. 25A is an isometric view showing the third orbiting attachment coupled to the Elliptical Massage Gun 100.

FIG. 25B is an enlarged isolated view of the third orbiting attachment.

FIG. 26A through 26G are views which show the affect upon the fascia by the third orbiting attachment as the piston moves from its 12 o'clock to 2 o'clock to 4 o'clock to 6 o'clock to 8 o'clock and to 10 o'clock, and to its 12 o'clock position.

FIG. 27A is a diagram showing the circular path of one axle of the third orbiting attachment. FIG. 27B is an enlarged view of the diagram shown in FIG. 27A.

FIG. 28A is an isometric view showing the fourth orbiting attachment coupled to the Elliptical Massage Gun 100.

FIG. 28B is an enlarged isolated view of the fourth orbiting attachment.

FIG. 29A is an isometric view showing the fifth orbiting attachment coupled to the Elliptical Massage Gun 100.

FIG. 29B is an enlarged isolated view of the fifth orbiting attachment.

FIG. 29C is an exploded isometric view of the components comprising the fifth orbiting attachment.

FIG. 30A through 30G are views which show the affect upon the fascia by the fifth orbiting attachment as the piston moves from its 12 o'clock to 2 o'clock to 4 o'clock to 6 o'clock to 8 o'clock and to 10 o'clock, and to its 12 o'clock position.

FIG. 31A is a diagram showing the circular path of one axle of the fifth orbiting attachment.

FIG. 31B is a view of the circular path of one axle of the fifth orbiting attachment and its virtual axis with its virtual axis.

FIG. 32A is an isometric view of Elliptical Massage Gun 100 with a stabilizing attachment.

FIG. 32B is a side view of Elliptical Massage Gun 100 with the stabilizing attachment of FIG. 32A.

FIG. 33A is an isometric view of Elliptical Massage Gun 100 with a stabilizing attachment having a roller.

FIG. 33B is a side view of Elliptical Massage Gun 100 with the stabilizing attachment of FIG. 33A.

FIG. 34A is an isometric view of Elliptical Massage Gun 600 shown with the second orbiting attachment.

FIG. 34B is an isometric view of Elliptical Massage Gun 600 shown with the fifth orbiting attachment.

FIG. 35A is an isometric view of Elliptical Massage Gun 600 shown with a stabilizing attachment and with the third orbiting attachment.

FIG. 35B is a side elevation view of the Massage Gun 600 that is shown in FIG. 35A.

FIG. 36A is an isometric view of another stabilizing attachment shown with the fifth orbiting attachment.

FIG. 36B is a side elevation view of the Massage Gun 600 that is shown in FIG. 36A.

### DETAILED DESCRIPTION OF PREFERRED EMBODIMENTS

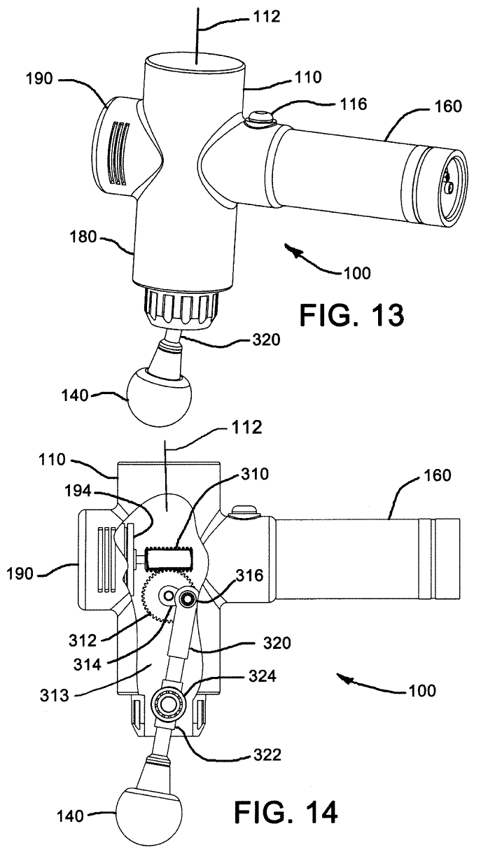

FIG. 13 illustrates an isometric view of one embodiment of the Elliptical Massage Gun. The device 100 comprises a housing including a main body 110 with a cavity 313 and a series of appendages for the purposes of housing the functional components. A spherical attachment 140 is mounted upon the distal end of a rotating piston 320 for the purpose of making oscillating massage motion upon a fascia surface. The main body 110 has a cavity 313 having an axis 112 which is intended to be maintained substantially perpendicular to the fascia surface upon which the attachment 140 oscillates. A cylindrical projection 190 projects perpendicular to axis 112 and has the function of housing the motor which reciprocates the piston. Another cylindrical projection 160 extends oppositely of the motor housing 190 and has the function of providing a single handle 160 which is designed to allow the user to operate the device by grasping the device 100 with one hand. Handle 160 extends from the cavity 313 along a single axis from the main body. In some embodiments the handle 160 contains a cavity which houses removeable and/or rechargeable batteries for powering the device motor. In other embodiments, the handle 160 is removeable and contains a battery pack capable of remote charging. The device motor is powered on and off by the pushbutton 116 which is accessible to the user's thumb while grasping the handle 160.

The piston drive mechanism is especially simple when compared to many prior art massage guns. FIG. 14 is a side elevation section view of the device 100 with the main body 110 shown in cut away fashion to expose the piston drive mechanism which resides within the main body 110. The device utilizes a single gear set comprising a worm screw and a worm gear to both rotate and translate the piston 320. A worm screw 310 is coupled to the shaft of the drive motor 194 and in mesh with the worm gear 312. An eccentric crank 314 is attached to the worm gear 312 and is rotationally driven by the worm drive.

The piston 320 possesses a ball bearing 316 which is rotationally attached to the eccentric at one distal end of the piston. The piston has a second distal end configured for mounting an attachment therefrom. The attachment 140 shown in FIG. 14 has a spherical shape and is one attachment selected from amongst a plurality of available orbiting attachments. The second distal end of the piston is configured for coupling one attachment therefrom, the one attachment selected from amongst the plurality of orbiting attachments, each of which is removably coupled to the second distal end of the piston.

The piston is supported and guided by the piston rocker 322 which possesses a circular bore 325 which slidably constrains the circular portion of the piston 320. The piston rocker 322 thus forms a rotational joint which allows the piston to both translate and rotate. Two ball bearings 324 are fixedly attached to the main body 110 and rotationally support the piston rocker 322. As the eccentric 312 rotates, the piston 320 slides within the bore of the piston rocker 322 and also rotates about the center of bearings 324.

The resulting piston movement is described as orbitally reciprocating. The second distal end of the piston moves in a circular path relative to the main body as a result of this motion. The orbitally reciprocating piston motion distinguishes device 100 from conventional massage guns whose pistons move only with straight line oscillation.

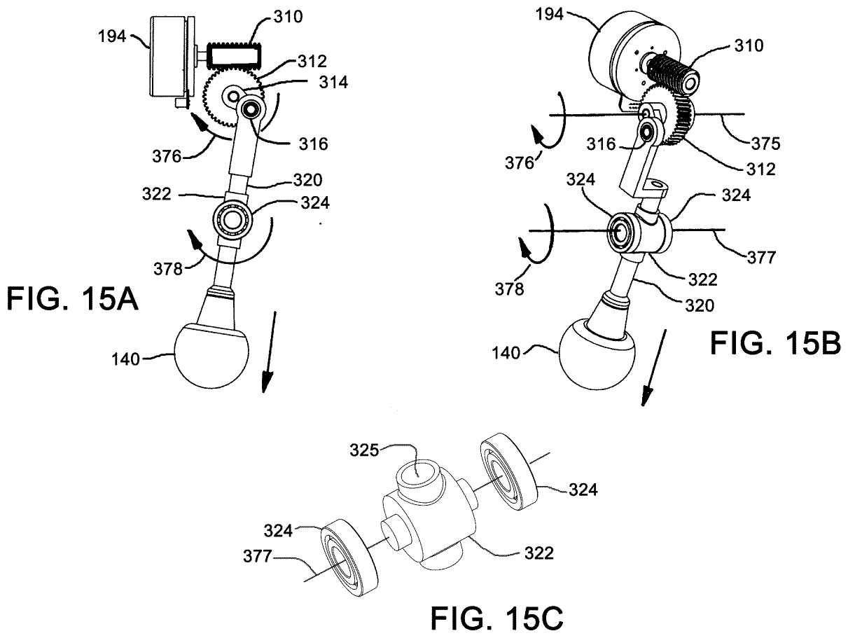

FIGS. 15A, 15B and 15C illustrate views of the orbitally reciprocating piston drive mechanism when isolated from the device 100. FIG. 15A is a side elevation view and FIG. 15B is an analogous isometric view of the simple mechanism which utilizes only one gear set to implement multi-axis massage forces. A single gear set comprising a worm screw 310 and a worm gear 312 is driven by a DC motor and rotates continuously when the device 100 is actuated. A connecting crank 314 is fixedly attached to the worm gear 312 and provides a journal for attaching the piston 320 to the rotating worm gear 312. Ball bearing 316 is attached to the piston 320 at its first (upper) distal end and the attachment 140 is removably coupled to the piston at its second distal end.

The single motor-driven gear set (310 and 312) is responsible for the multi-axis motion of the attachment 140. Referring to FIG. 15C, the piston 320 derives its guidance from a piston rocker 322 which rotates within ball bearings 324, where the ball bearings 324 are fixedly attached within the housing 180. The circular portion of piston 320 is captured within the bore 325 of the piston rocker 322 which constrains the piston to reciprocate within the bore, whose axis rotates about the axis of ball bearings 324. The arrows in FIG. 15A and FIG. 15B explain that the piston 320 both rotates and translates as the worm gear 312 continuously rotates. As will be explained more fully below, the combined rotation and translation of the piston 320 induces the attachment 140 to orbit along a circular path. Referring to FIG. 15B, the piston rocker is configured to rotate about an axis 377 which is parallel to the fascia surface when the device is maintained in the intended orientation.

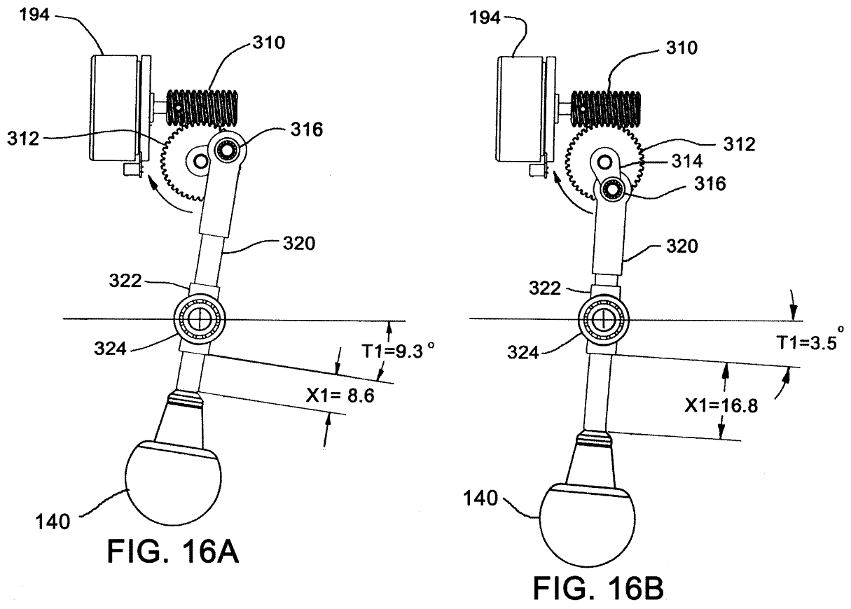

FIG. 16A and FIG. 16B illustrate the combined rotating and reciprocating motion of the piston movement which explains the term “orbitally reciprocating”. The worm gear 312 is rotating CW in FIG. 16A where the piston bearing 316 is shown at about the two o'clock position on gear 312. The worm gear 312 continues to move CW in FIG. 16B and has advanced to the 5 o'clock position. During this movement, the piston 320 translates (slides) within the bore 325 of piston rocker 322 (see FIG. 13C) which increases the distance X1 from 8.6 mm to 16.8 mm. The attachment 140 is thus continuously expanding and contracting its distance from the piston rocker as the worm gear rotates.

During this translation of the piston 320 from 8.6 mm to 16.8 mm, the piston rocker 322 rotates within the ball bearing 324 which if fixedly attached the main body of the device 100. That rotation changes the indicated angle T1 from 9.3 degrees to 3.5 degrees as the piston 320 is configured to both slide and rotate within the piston rocker 322.

During an entire rotation cycle (360 degrees) of worm gear 312, the dimension X1 achieves a maximum and a minimum dimension as the piston reciprocates within the bore 325 of the piston rocker 322. Rotation of the piston rocker is configured to also cause an axis of the piston to continuously change its angle with the fascia surface. The angle T1 is constantly changing while the worm gear 312 rotates. The piston 320 is simultaneously orbiting angularly about the rotation center of ball bearing 324 as indicated by the everchanging angle T1. As the piston 320 both slides and rotates within the piston rocker 322, the resulting motion of the piston 320 is summarily described as “orbitally reciprocating”.

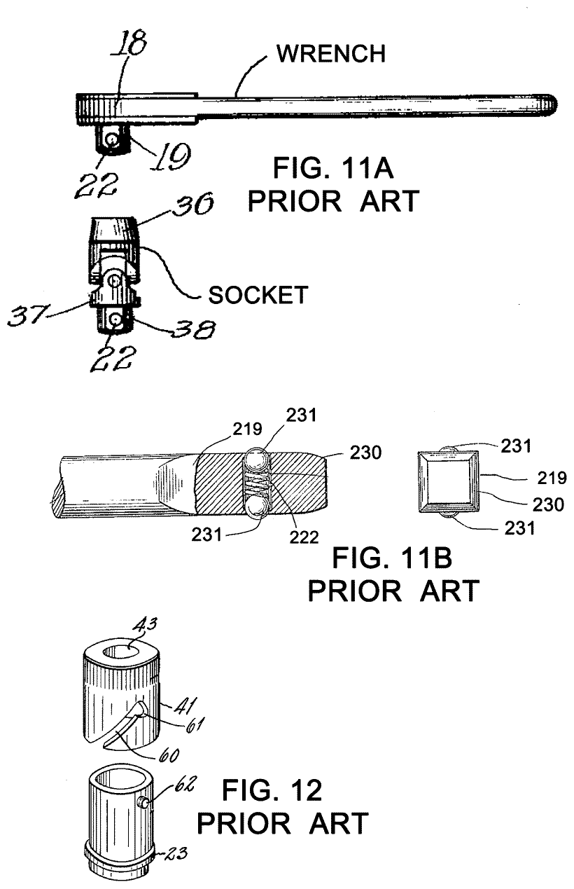

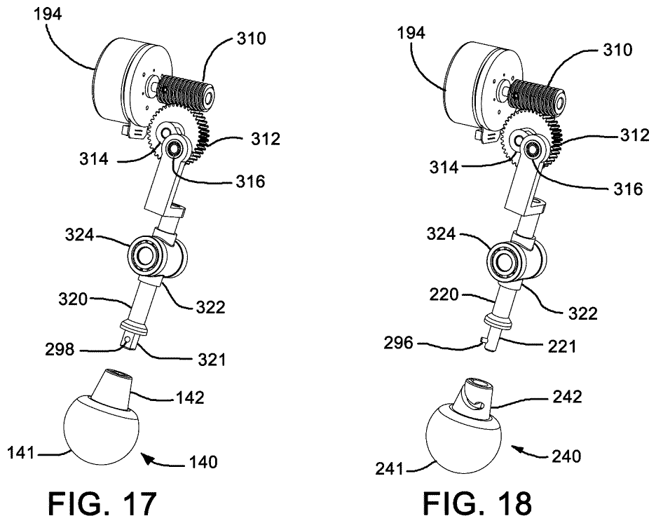

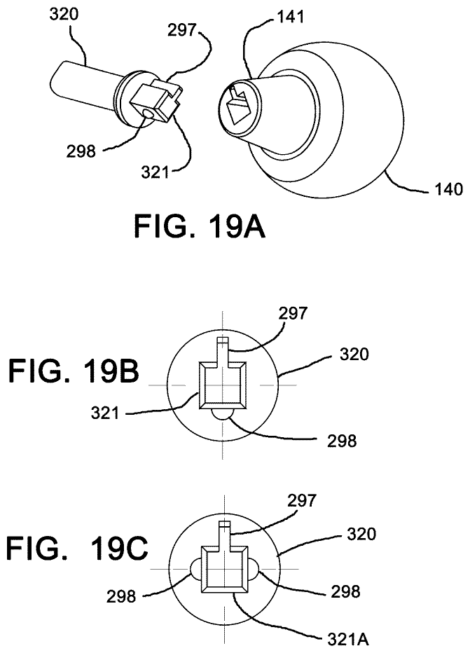

For purposes of describing the plurality of orbiting attachments, the attachment 140 is designated as the first orbiting attachment. In one embodiment, the first orbiting attachment and others are coupled to the second distal end of the piston 320 by a “ball detent” coupler which was taught by the 1925 patent which is shown in FIG. 11. The coupler and the “ball detent” attachment 140 are shown detached in FIG. 17 where the spring-loaded ball 298 resides on the rectangular stem 321 on the second distal end of the piston 320. Referring to FIG. 17, the second distal end of the piston is configured as a square stem 321within which the spring-loaded ball resides. FIG. 19A, FIG. 19B and FIG. 19C show additional detail of the stem 321 which carries the ball detent.

In an alternate embodiment, the plurality of attachments utilize the “bayonet mount” coupling which was taught by the 1952 patent that is illustrated in FIG. 12. FIG. 18 illustrates the embodiment which incorporates the “bayonet mount” where the cam pin is labeled 296. The plurality of attachments which utilize this configuration will have a stem 242 which possesses a cam grove as shown by the attachment 240 in FIG. 18.

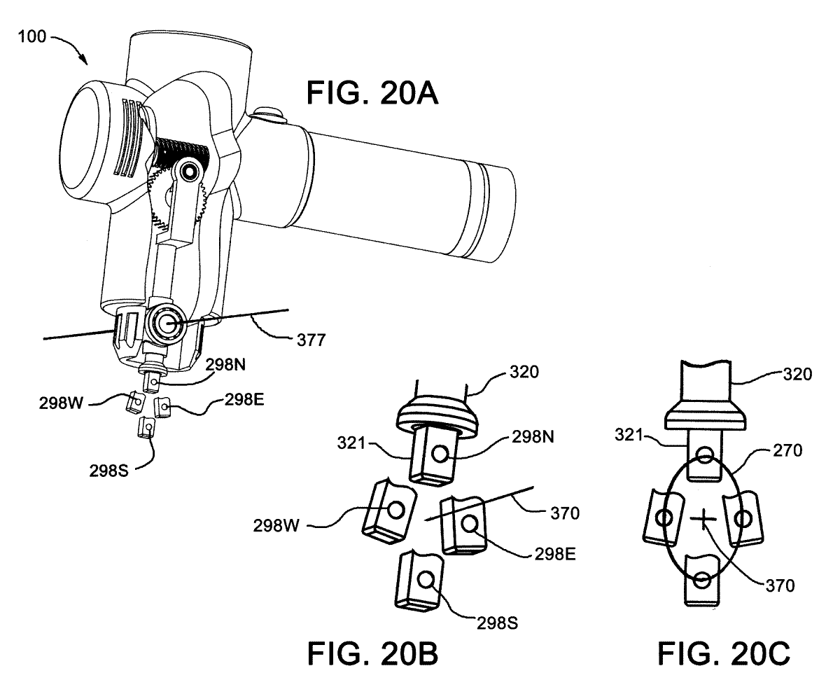

Referring to FIG. 19A, this illustration shows an isometric view of the piston stem 321 looking from the terminal end of the piston 320. Attachment 140 has a first portion comprising a stem 141 whose purpose is for removably coupling the attachment to the circular path of the orbitally reciprocating piston (see FIG. 20C). Stem 321 of the piston 320 is generally square and includes a blade projection 297 which is located on an opposite surface as the detent ball 298. FIG. 19A also shows the mating female shape in the stem 141 of attachment 140 which mounts upon stem 321. The blade 297 functions to orient the plurality of attachments relative to the axis 377 of the piston rocker 322.

FIG. 19B is an end view of the piston stem 321 as shown in FIG. 19A, which explains the relation between the spring-loaded ball 298 and the orientation blade 297. FIG. 19C illustrates an alternate embodiment of the piston stem 321 wherein two opposing spring-loaded balls are utilized as taught by the 1926 patent which is shown in FIG. 11B. In this embodiment, the orientation blade 297 resides on a surface adjacent to the surfaces occupied by each of the two spring-loaded balls.

A unique characteristic of the device 100 is the resulting orbital motion of the distal end of the piston 320 which orbits about a virtual axis, where the term “virtual axis” is construed to mean an axis in space having no physical axle or no physical bearing. FIG. 20A illustrates the multiple positions of the stem 321 at the second distal end of the piston as it moves along its circular path, where the second distal end in this illustration utilizes the ball detent coupler of stem 321 as shown in FIG. 17 and FIG. 19A. The spring-loaded ball 298 is shown in four instantaneous positions along its circular path. Using a compass direction analogy, the ball positions are represented as 298N (north), 298E (east), 298S (south) and 298W (west).

FIG. 20B is an enlarged view of the spring-loaded ball positions as shown in FIG. 20A. It can be observed that the spring-loaded ball 298 orbits circularly about a virtual axis as the worm gear 312 completes each 360-degree cycle. The virtual axis is labeled as axis 370 where the axis 370 is parallel to the axis 377 of the piston rocker 322. It can be observed that extreme positions of the piston 298N, 298E, 298S and 298W are instantaneous positions located on the orbital path having virtual axis 370. The virtual axis 370 is parallel to the axis 377 of the piston rocker 322, and virtual axis 370 also resides within a plane that is substantially parallel to the fascia surface. FIG. 20C is an enlarged view of the four instantaneous positions of the spring-loaded ball, where the view is looking at one face of the piston stem 321. The actual path of the spring-loaded ball 298 as shown in FIG. 20C is an ellipse 270 which has a major axis and minor axis having different dimensions from a common center, where the common center is the virtual axis 370.

The second distal end of the piston is thus following a circular path 270 which is elliptical in this embodiment. The circular path 270 is configured to reside within a plane that is perpendicular to the fascia surface.

### First Orbiting Attachment

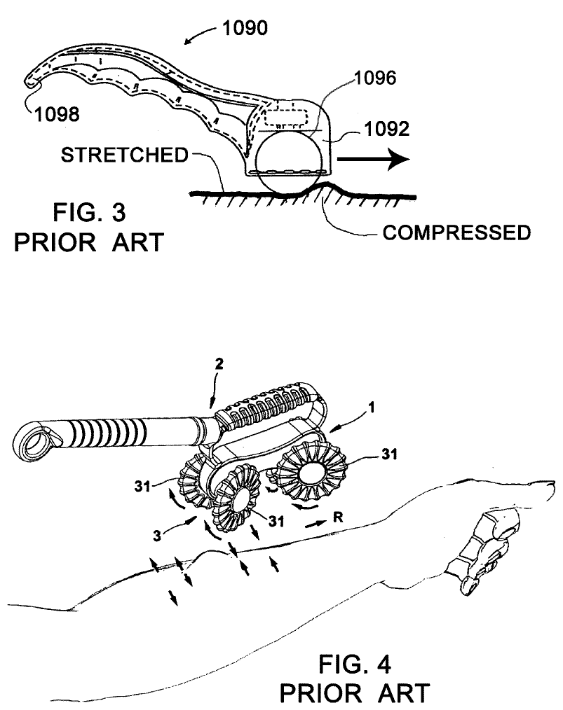

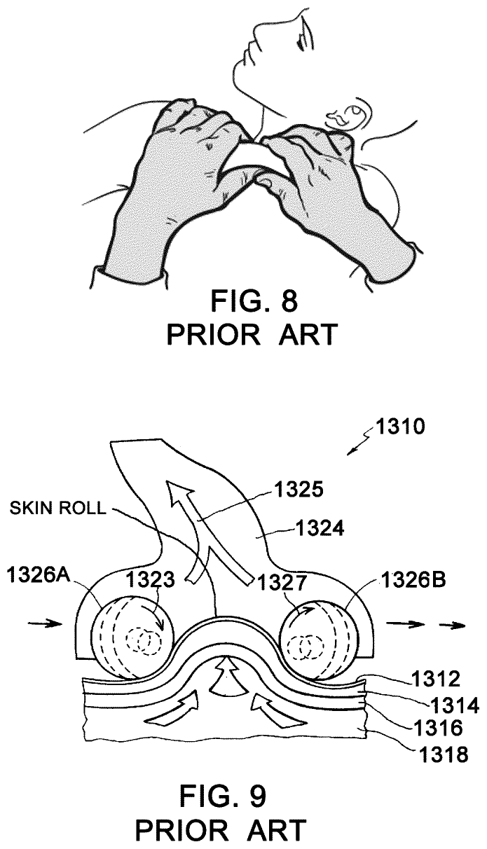

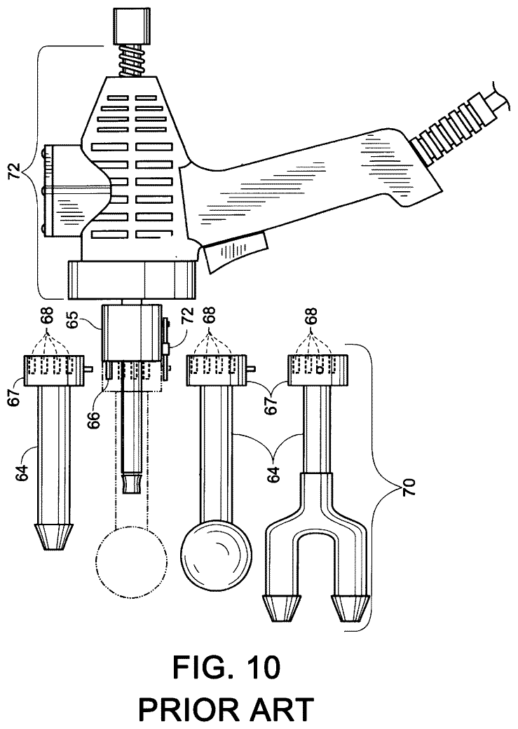

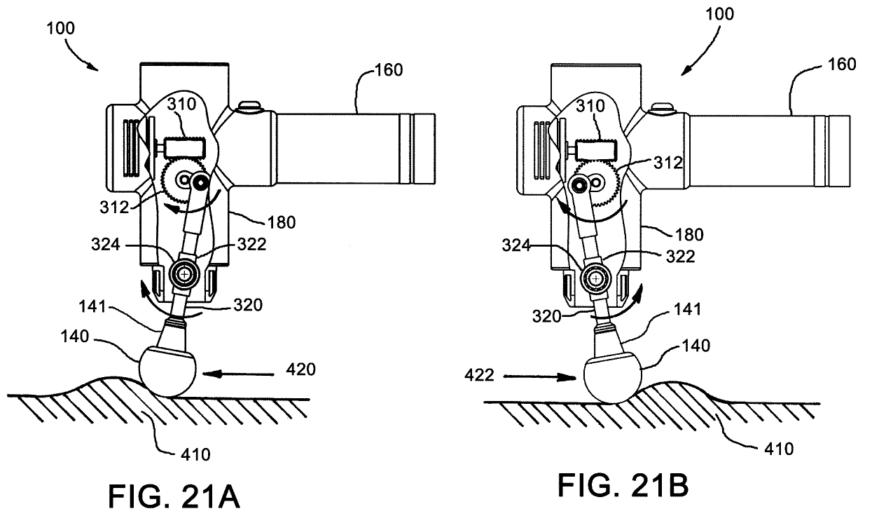

Each attachment has a first portion which is removably coupled to the piston and has at least one contact portion for making oscillating contact with the facia surface. Stem 141 comprises the first portion and the contact portion of the first attachment 140 is comprised of a partial sphere having a centroid defined by the center of the sphere. The orbital reciprocation of the piston is configured to cause each attachment to reciprocate along the fascia surface with bidirectional excursions. FIG. 21A and FIG. 21B illustrate the range of movement of the first attachment 140 as it moves relative to the generalized plane of the fascia surface 410. This kneading motion (see FIG. 8) is illustrated by the directional arrows which indicate the relative motion of the attachment 140 as it creates the travelling compressive waves in both directions along the fascia surface in the same manner as shown in FIG. 3. Referring to FIG. 21A, the gear 312 is rotating CW, inducing piston 320 to rotate the piston rocker CW about ball bearing 324 while moving the attachment 140 in the direction of arrow 420. Referring to FIG. 21B, the gear 312 is rotating CW, inducing piston 320 to rotate CCW about ball bearing 324 while moving the attachment 140 in the direction of arrow 422.

Once the stem 141 of the attachment is coupled to the second distal end of orbiting piston 320, the stem follows the circular path of the orbitally reciprocating piston. Moreover, each and every portion of the first attachment orbits in a circular path. For example, the centroid of the spherical shape orbits along a circular path wherein the circular path has its own virtual axis at its center.

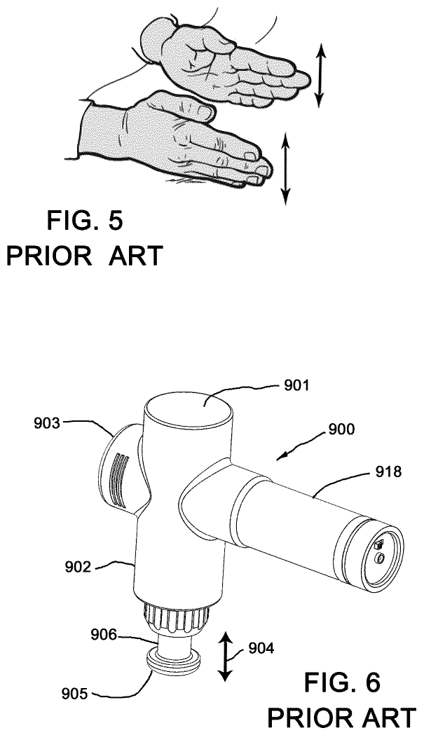

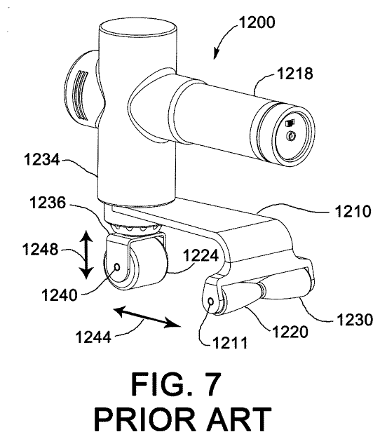

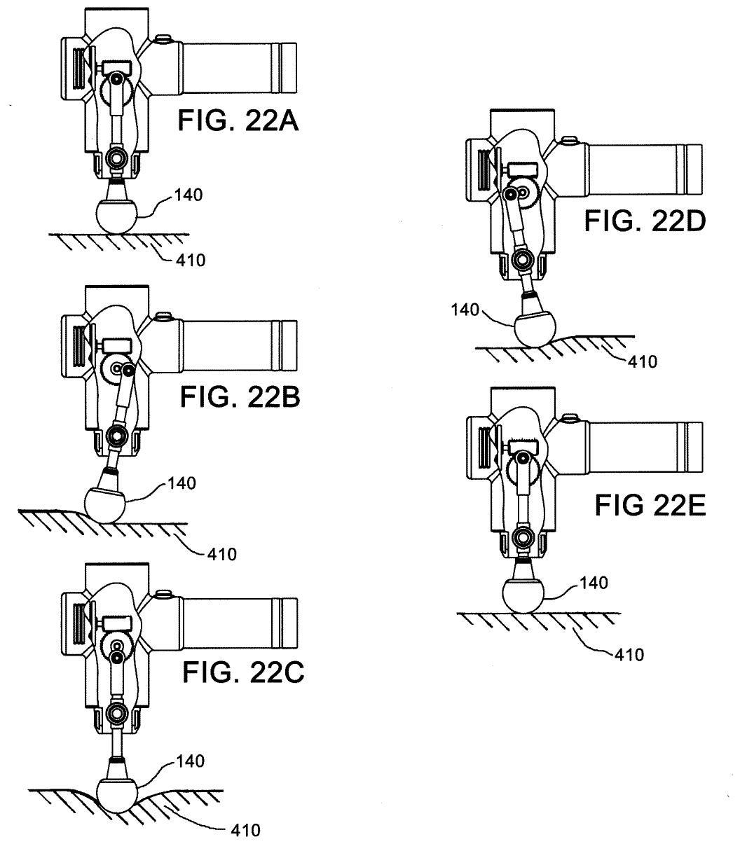

FIGS. 22A, 22B, 22C, 22D, and FIG. 22E show the relative motion upon the fascia surface as the attachment 140 moves along its elliptical path relative to the main body. Orbiting attachment 140 is shown in its most withdrawn position in FIG. 22A. The attachment has moved downward and leftward in FIG. 22B. FIG. 22C shows the condition where the attachment has reached its maximum penetration into the fascia. The attachment has begun its withdrawal while moving rightward in FIG. 22D. FIG. 22E shows the attachment having completed its elliptical path and returned to the position of maximum withdrawal. These figures illustrate the ideal condition whereupon the massage gun handle is held perfectly steady relative to the fascia surface. The first attachment teaches the combination of percussive massage and kneading as shown in FIG. 5 and FIG. 8. This massage motion is not possible with conventional massage guns having fixed-axis pistons.

### Second Orbiting Attachment

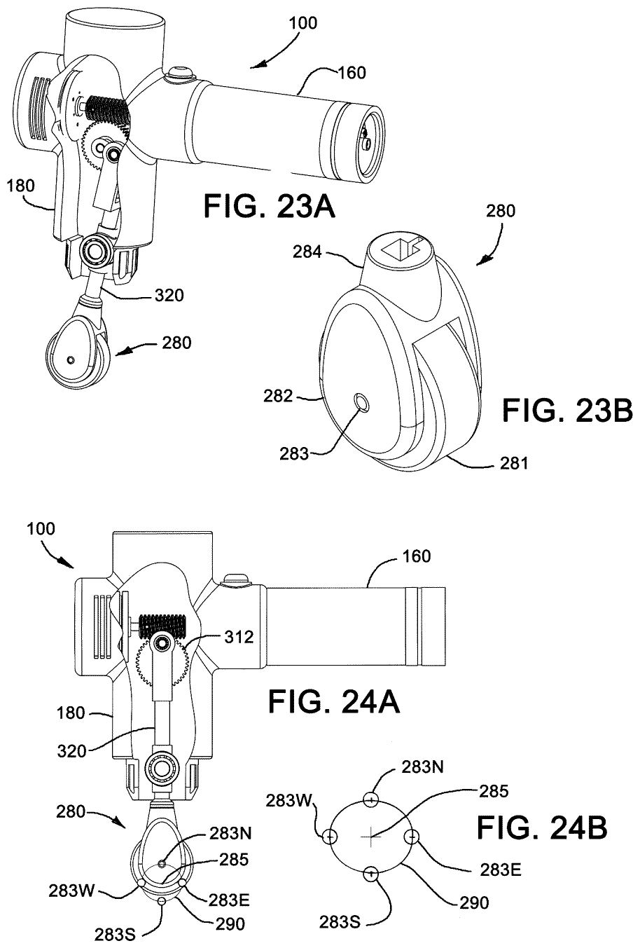

A second orbiting attachment 280 is shown in FIG. 23A and contains a roller 281 for bearing against the fascia surface. Attachment 280 includes a first portion (stem 284) for removably coupling the attachment to the piston 320 and a distal end 282 extending therefrom. The distal end comprises the roller housing 282 and the roller 281 for making contact with the fascia surface as shown in FIG. 23B. Once the stem 284 of the attachment is coupled to the second distal end of orbiting piston 320, the stem follows the circular path of the orbitally reciprocating piston. Moreover, each and every portion of the second attachment orbits in a circular path. Roller 281 rotates freely upon axle 283 as it orbits about a virtual center.

FIG. 24A and FIG. 24B illustrate the circular path 290 that is travelled by the axle 283 during one revolution of the worm gear 312. In FIG. 24A, the attachment 280 is shown in the position corresponding to the state wherein the first distal end of the piston is located at 12 o'clock on the gear 312. The label 283N represents the actual position of the axle in that state. Using the analogy of compass angles, the labels 283E, 283S and 283W represent instantaneous axle positions located along the orbital path 290 which is superimposed on the view in FIG. 24A.

FIG. 24B is an enlarged view of the superimposed axle positions shown in FIG. 24A. The diagram represents the circular path of the axle 283 as it orbits about its virtual axis 285. The virtual axis 285 is parallel to the axis 377 of the piston rocker 322, and virtual axis 285 also resides within a plane that is substantially parallel to the fascia surface. The circular path 290 resides in a plane that is perpendicular to the fascia surface when the user maintains the massage gun in the intended orientation.

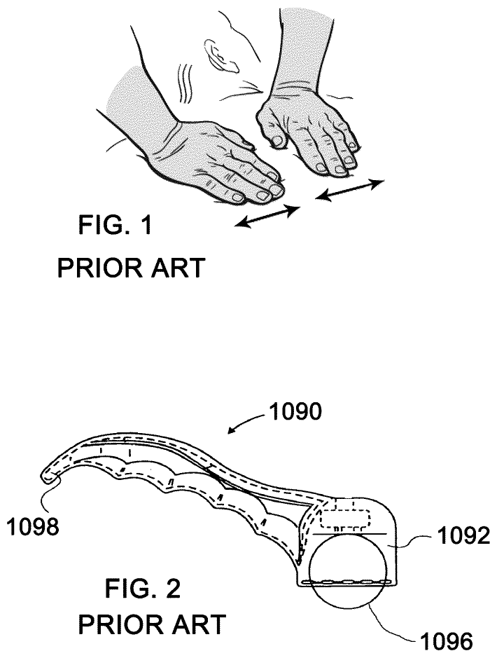

The attachment 280 is utilized for simulating the combined massage techniques of myofascial release motion (see FIG. 1) and tapotement (see FIG. 5), and achieves similar reciprocation affects as shown in FIG. 22A through FIG. 22E.

### Third Orbiting Attachment

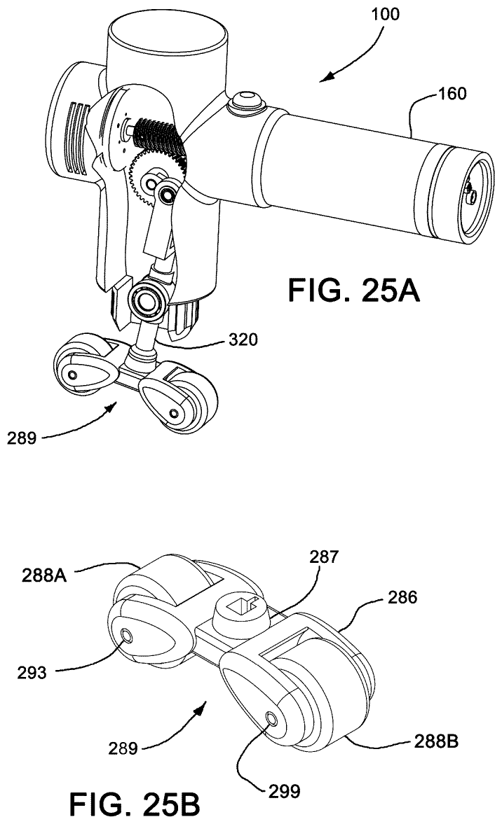

A third orbiting attachment 289 is shown in FIG. 25B and contains a first portion comprised of stem 287 and two distal ends rigidly extending therefrom which form roller housing 286. Each of the two distal ends possesses a contact portion comprising a freely rotating roller. A first roller 288A is supported upon a first axle 293 while a second roller 288B is supported upon a second axle 299. Roller housing 286 adjoins the two rollers to the stem 287, wherein the stem 287 is utilized for coupling attachment 289 to the second distal end of the piston 320 as shown in FIG. 25A.

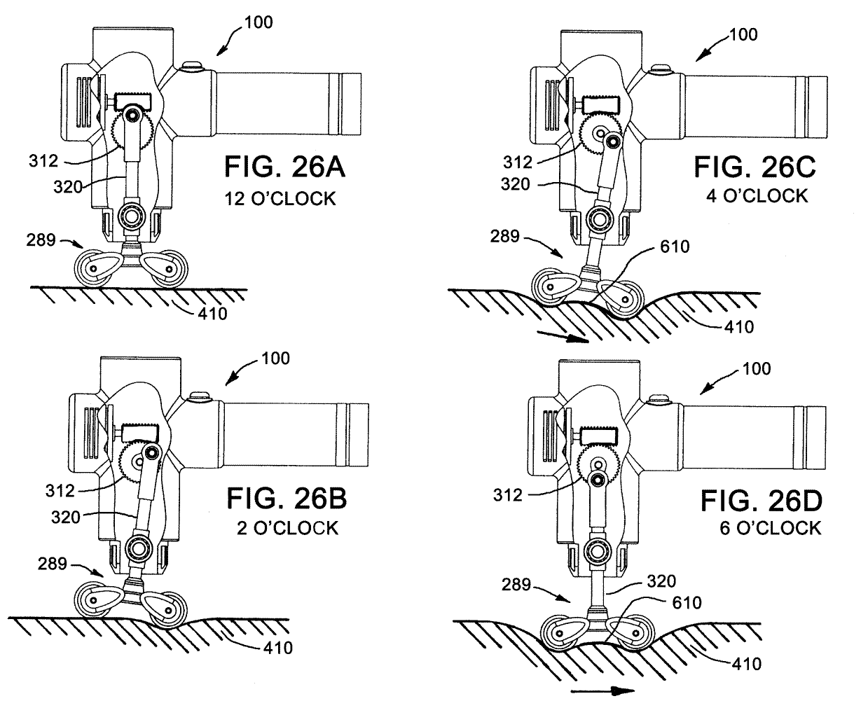

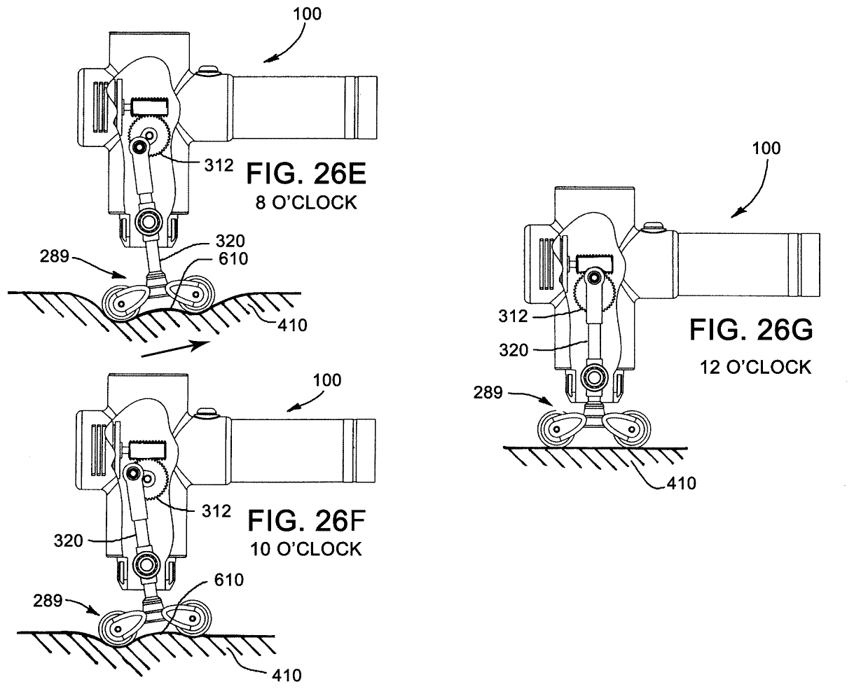

The third attachment is utilized for “Petrissage”, wherein “Petrissage” is a technique commonly used by therapists to treat cellulite by “skin rolling” and “kneading” the fat deposits that are trapped in pockets of the upper epidermis region (see FIG. 8). FIG. 26A through FIG. 26G illustrate the sequence of positions that achieve “skin rolling and “kneading” action with the third attachment 289.

The FIGS. 26A, 26B 26C, 26D, 26E, 26F, and 26G each represent an advancement of upper distal end of the piston using the analogy of a clock, wherein FIG. 26A shows the orientation of attachment 289 when the upper end of the piston 320 is oriented at the 12'oclock position upon worm gear 312. As the piston rotates, a skin roll 610 is entrapped between the two rollers and is rolled along the fascia surface until the piston again returns to its 12'oclock position. The arrows in FIG. 26C through FIG. 26E indicate the direction of the skin roll 610 as it traverses from left to right in the figures. The traversing motion of the skin roll cyclically repeats as the motor continues to rotate.

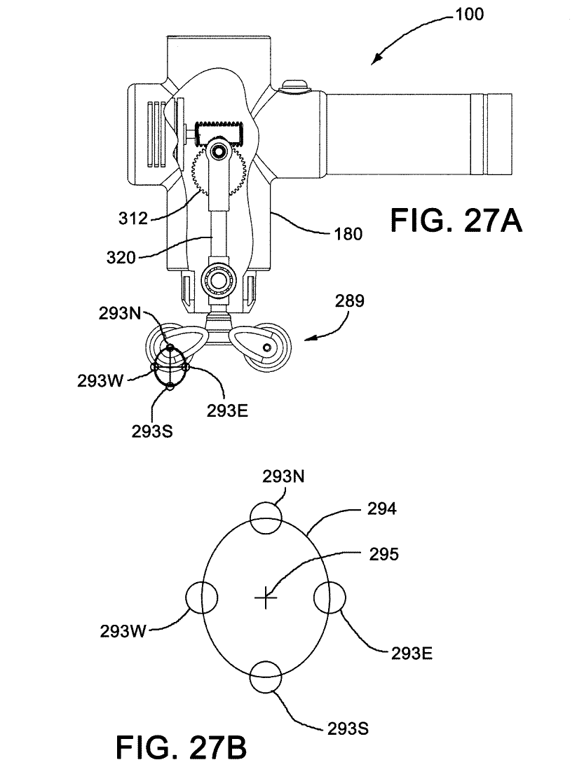

Once the stem 287 of the attachment is coupled to the second distal end of orbiting piston 320, the stem follows the circular path of the orbitally reciprocating piston. Moreover, each and every portion of the third attachment orbits in a circular path. Each of the rollers 288A and 288B orbits about its own circular path as a result of the orbitally reciprocating piston motion. FIG. 27A illustrates the relative position of the attachment 289 when the upper end of piston 320 is located at its 12 o'clock position. Label 293 shows the position of the axle 293 at this state. Using a compass analogy, the extreme axle positions are represented as 293N (north), 293E (east), 293S (south) and 293W (west) wherein each circle indicates an instantaneous position of the axle along its circular path which is superimposed upon the view.

FIG. 27B is an enlarged view of the circular path as shown in FIG. 27A. It can be observed that axle 293 orbits circularly about a virtual axis as the worm gear 312 completes each 360-degree cycle. The virtual axis is labeled as axis 295 where the axis 295 is parallel to the axis 377 of the piston rocker 322. It can be observed that extreme positions of the piston 293N, 293E, 293S and 293W are instantaneous positions located on the circular path 294 having virtual axis 295. The virtual axis 295 is parallel to the axis 377 of the piston rocker 322, and virtual axis 295 also resides within a plane that is substantially parallel to the fascia surface. The second axle 299 also orbits about its own circular path having its own virtual axis. The circular path of axle 299 is exactly the same size and shape as the circular path 294 as shown in FIG. 27B.

### Fourth Orbiting Attachment

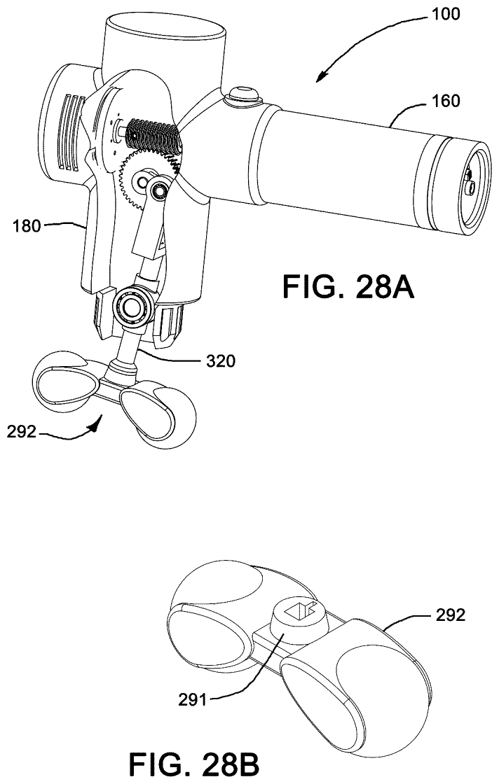

A fourth orbiting attachment 292 is shown in FIG. 28B and contains a first portion 291 and two distal ends extending rigidly therefrom which are formed as an injection-molded unibody component. Each of the two distal ends possesses a contact portion which comprises a non-rolling spherical surface for bearing against the fascia surface. The stem portion 291 is utilized for coupling attachment 292 to the second distal end of the piston 320 as shown in FIG. 28A.

Once the stem 291 of the attachment is coupled to the second distal end of orbiting piston 320, the stem follows the circular path of the orbitally reciprocating piston. Moreover, each and every portion of the fourth attachment orbits in a circular path. The structure of the fourth orbiting attachment 292 is geometrically similar to the third orbiting attachment with the exception that the spherical contact portions do not roll upon the fascia surface. The rolling motion of the overall attachment 292 is therefore identical to the incremental motion steps taught in FIG. 26A through FIG. 26G. Each of the two spherical contact portions orbits along its own circular path about its own virtual axis as illustrated in FIG. 27B.

### Fifth Orbiting Attachment

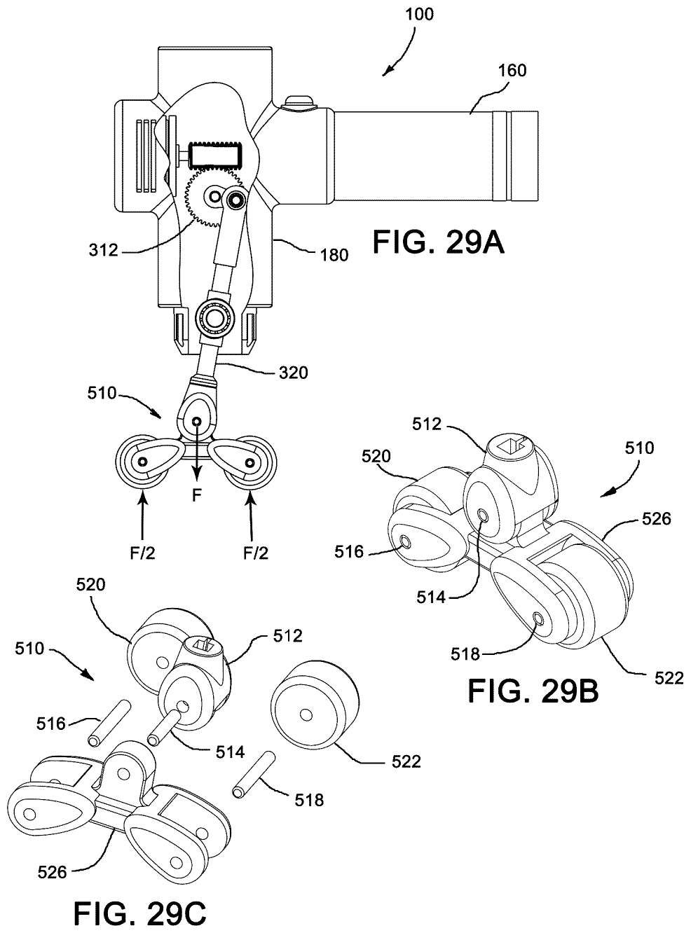

A fifth orbiting attachment 510 is shown in FIG. 29B and contains a first portion 512 and three axles. The first axle 514 is mounted to a distal and of the stem 512 and supports a rocker 526 which pivots thereon. The rocker 526 possesses a first distal end for receiving the stem 512 and two distal ends extending rigidly therefrom having a second axle 516 and a third axle 518. Each of the two distal ends of the rocker 526 possesses a contact portion which comprises a freely rotating roller. A first roller 520 is supported upon the second axle 516 while a second roller 522 is supported upon the third axle 518. Axle 514 adjoins the rocker 526 to the stem 512, wherein the stem 512 is utilized for coupling attachment 510 to the second distal end of the piston 320 as shown in FIG. 29A. FIG. 29C is an exploded view of the attachment 510 which is shown for clarification of the components.

Orbiting attachment 510 is configured to entrap a skin roll and to move the skin roll in reciprocating fashion along the fascia surface. This massage action is mechanizing the myofascial release technique as shown in FIG. 1 combined with the petrissage (skin rolling) technique as shown in FIG. 8.

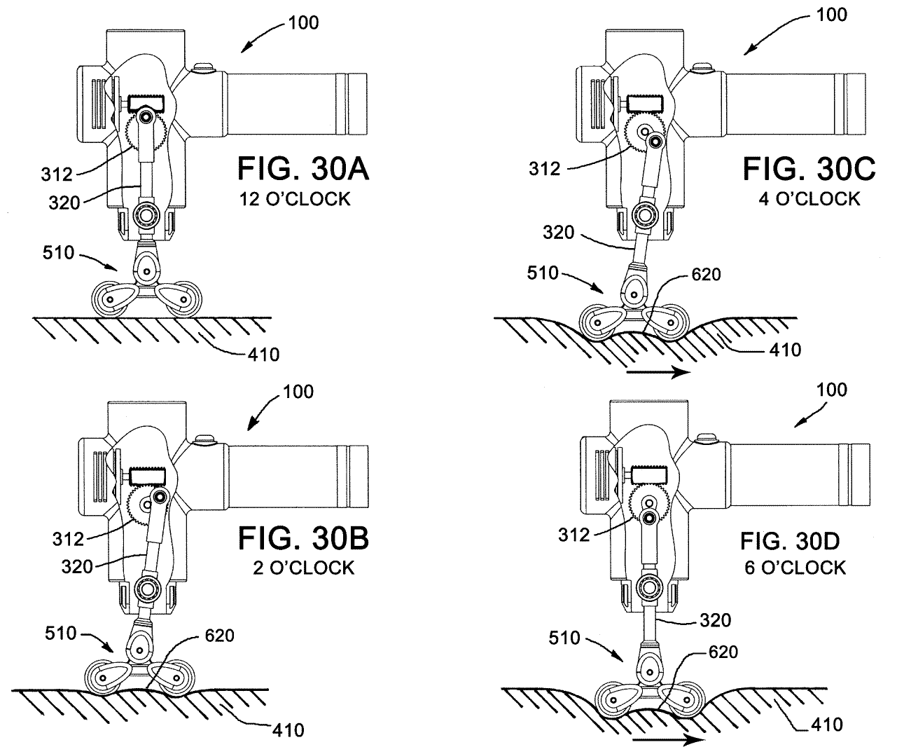

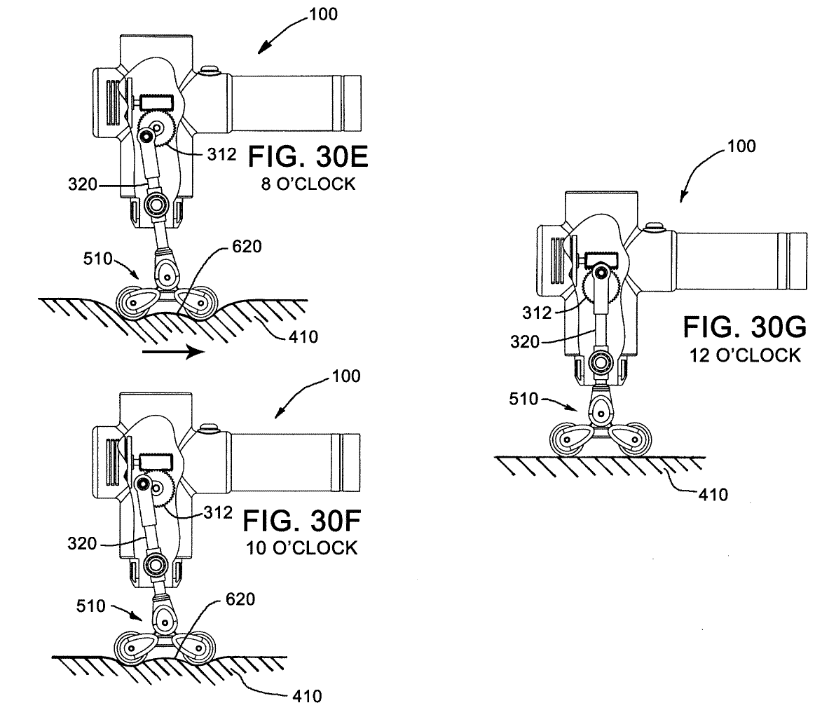

The massage action induced by the fifth orbiting attachment 510 can be appreciated by viewing the iterative motion sequence explained in FIG. 30A to FIG. 30G where a skin roll 620 is entrapped and thereafter traversed along the fascia surface during each cycle as the worm gear 312 rotates through a full revolution. The fifth attachment simulates the combined technique of petrissage (“skin rolling” and “kneading”) with tapotement (percussion).

The rocker 526 of attachment 510 is maintained substantially parallel to the plane of the fascia as the piston 320 orbits. Referring to FIG. 29A, the axle 154 on the attachment 510 transmits the user's downward force F to the rocker 526. Since the rollers 520 and 522 are equidistant to the axle 154, the reaction force is equally distributed as illustrated by the two equivalent opposing vectors F/2 in the figure. As long as the fascia density underlying each roller is the same, the two rollers penetrate the fascia at identical depths, thus facilitating the unique traversing skin roll action as shown in the sequence of FIGS. 30A, 30B, 30C, 30D, 30E, and 30G where the skin roll 620 migrates from left to right in the sequence of figures. The arrows in FIG. 30C through FIG. 30E indicate the direction of the skin roll 620 as it traverses. The traversing motion of the skin roll cyclically repeats as the motor continues to rotate.

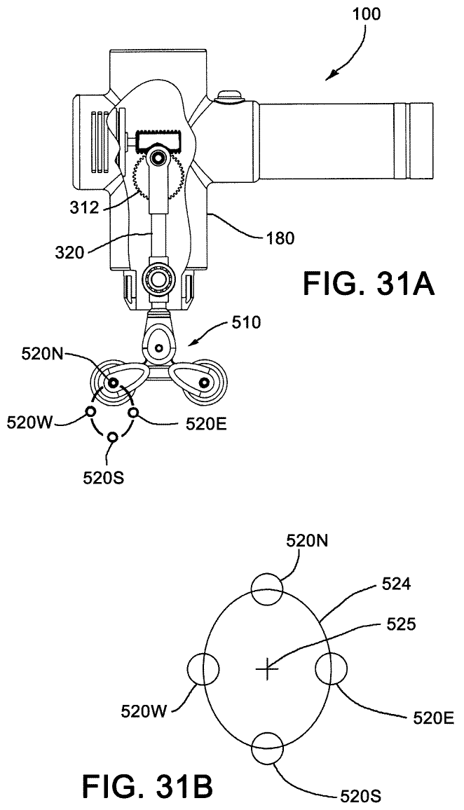

Once the stem 512 of the attachment is coupled to the second distal end of orbiting piston 320, the stem follows the circular path of the orbitally reciprocating piston. Moreover, each and every portion of fifth attachment orbits in a circular path. FIG. 31A and FIG. 31B illustrate the circular path followed by the roller 520 as the attachment 510 orbits. In FIG. 31A, the roller 520 is shown in the position corresponding to the state wherein the first distal end of the piston is located at 12 o'clock on the gear 312. The label 520N represents the actual position of the axle 516 of the roller 520 in that state. Using the analogy of compass angles, the labels 520E, 520S and 520W represent instantaneous roller axle positions located along the circular path 524 which is superimposed on the view in FIG. 31A. FIG. 31B is an enlarged view of the superimposed axle positions shown in FIG. 31A. The diagram represents the circular path 524 of the axle 520 as it orbits about its virtual axis 525. The virtual axis 525 is parallel to the axis 377 of the piston rocker 322, and virtual axis 525 also resides within a plane that is substantially parallel to the fascia surface. The circular path 525 resides in a plane that is perpendicular to the fascia surface when the user maintains the massage gun in the intended orientation. The roller 522 also follows the same orbital path as shown in FIG. 31B.

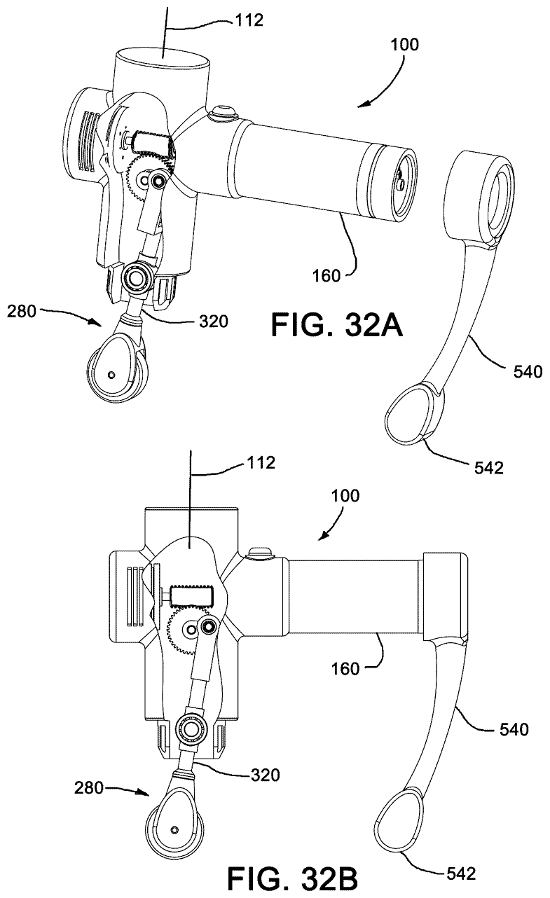

In another embodiment, a stabilizing attachment is coupled to the massage gun 100 for the purpose of maintaining the device upright. FIG. 32A and FIG. 32B illustrate an attachment 540 that is configured to assist the user in maintaining the main axis 112 perpendicular to the fascia surface. The attachment includes a proximal end removably coupled to the housing and having a distal end extending therefrom, the distal end including a contact portion configured for contacting the fascia surface while supporting the main axis perpendicular to the fascia surface. In this embodiment, the stabilizing attachment is coupled to the handle 160 by a friction fit and possesses a curvilinear portion 542 for bearing against the fascia surface. FIG. 32B is a side view of the massage gun 100 having stabilizing attachment 540 paired with orbiting attachment 280 (the second attachment).

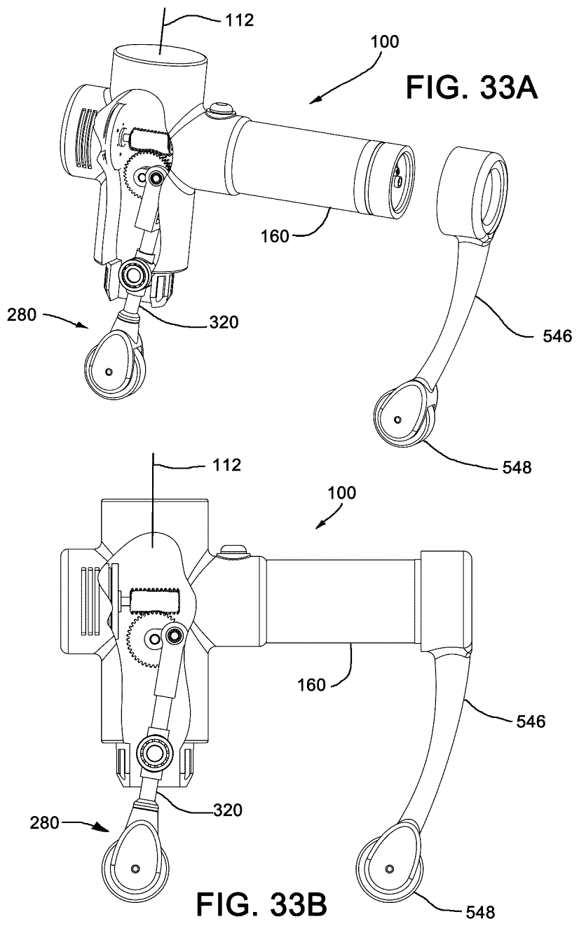

An alternate embodiment is shown in FIG. 33A which utilizes a similar stabilizing attachment 546 that possesses a roller 548 at its distal and for contacting the fascia surface. The geometry of the roller 281 of attachment 280 and the roller 548 aid the user in keeping the main axis 112 perpendicular to the fascia surface. FIG. 33B illustrates a side view of massage gun 100 showing the stabilizing attachment 546 when used with the orbiting attachment 280. This combination of orbiting attachment 280 (second attachment) and stabilizing attachment 546 facilitates the use of the Elliptical Massage Gun for producing reciprocating strokes along the fascia surface.

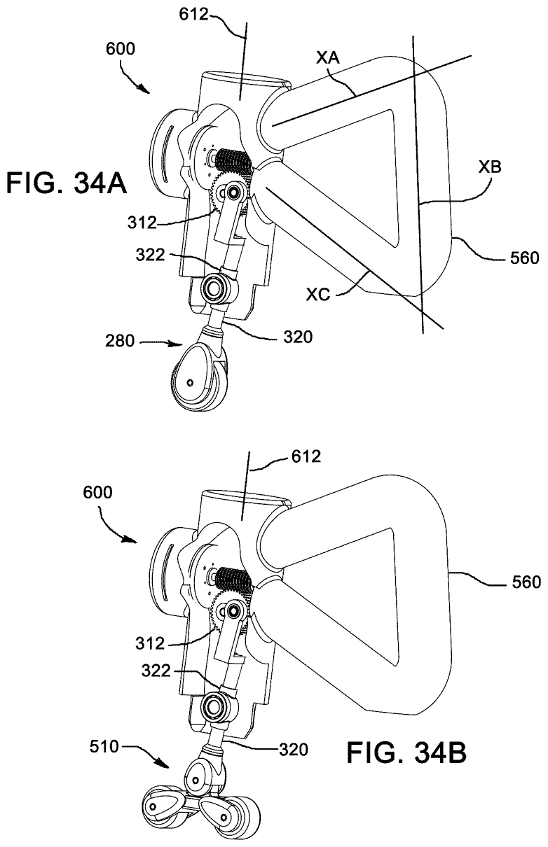

The Elliptical Massage Gun may gain additional utility by incorporating a handle having multiple handle portions wherein each handle portion defines an axis substantially different from the other portions. Massage gun embodiment 600 is shown in FIG. 34A where the handle 560 includes three handle portions, wherein each portion defines a different axis than the others. Handle 560 comprises a first handle portion that defines a first axis XA, a second handle portion that defines a second axis XB and a third handle portion that defines a third axis XC, and wherein the three handle axes intersect to form a triangle and wherein all three axes reside within the same plane. FIG. 34A illustrates the Elliptical Massage Gun 600 when utilizing attachment 280 (second attachment) and FIG. 34B illustrates the Elliptical Massage Gun 600 when utilizing the orbiting attachment 510 (fifth attachment).

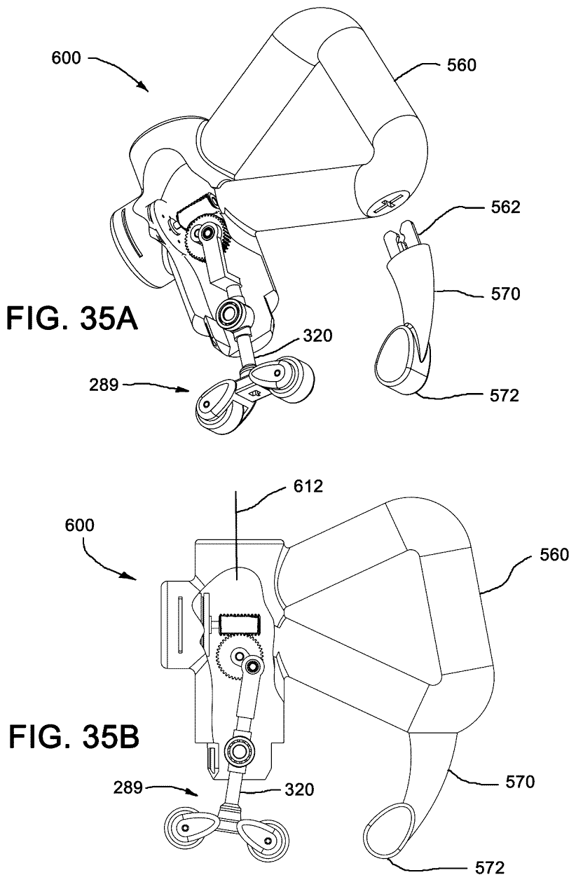

An alternate embodiment of the Elliptical Massage Gun 600 includes a triangular handle 560 that is configured for receiving a stabilizing attachment 570 which has the function of maintaining the massage gun in an upright orientation. FIG. 35A illustrates a stabilizing attachment embodiment 570 which utilizes a blade mount 562 for coupling to the massage gun. The distal end of attachment 570 possesses a curvilinear portion 572 for bearing against the fascia surface while aiding the user in maintaining the axis 612 relatively perpendicular to that fascia surface. FIG. 35B illustrates a side elevation view of massage gun 600 with stabilizing attachment 570 paired with orbiting attachment 289 (third attachment) when using massage gun 600 for treating cellulite.

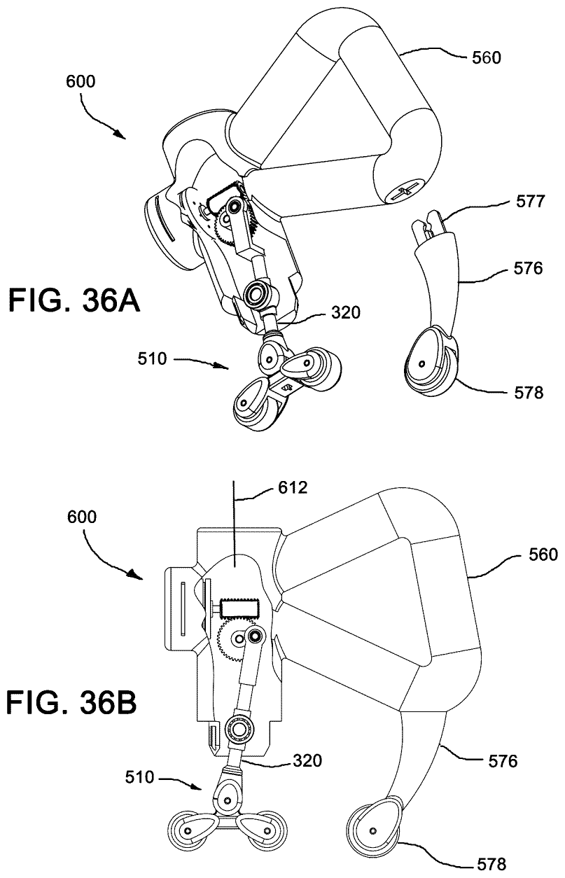

An alternate stabilizing attachment embodiment 576 includes at least one freely rotating roller 578 on its distal end for contacting the fascia surface as shown in FIG. 36A. Attachment 576 aids the user in maintaining the axis 612 relatively perpendicular to the fascia surface. The side elevation view in FIG. 36B illustrates the stabilizing attachment 576 paired with orbiting attachment 510 (fifth attachment) wherein these two attachments to the Elliptical Massage Gun 600 are combined for the purpose facilitating a reciprocating user motion along the fascia surface while attachment 510 orbits against the fascia.

Variations of these embodiments may be apparent to one of ordinary skill. Other numbers of percussive rollers, other roller shapes and other numbers or roller-supporting spindles could be utilized without deviating from the scope of the invention. Attachments for stabilizing the massage gun orientation may assume any number shapes. Other types of motors and other types of power transmission devices could also be utilized. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A handheld self-powered percussive massage gun for utilization by a user upon a fascia surface comprising:
a housing including a cavity and a handle portion extending therefrom along an axis, the handle portion configured to be graspable by the user for operating the percussive massage gun with one hand upon the fascia surface;
the housing cavity having a main axis configured to be oriented perpendicular to the fascia surface;
a piston orbitally reciprocating within a piston rocker while rotatably attached to an eccentric at a first distal end received within the cavity of the housing;
the piston rocker configured to rotate about an axis which is parallel to the fascia surface;
wherein rotation of the piston rocker is configured to cause an axis of the piston to continuously change its angle with the fascia surface;
the piston having a second distal end configured for coupling one attachment therefrom, the one attachment selected from amongst a plurality of orbiting attachments;
the second distal end of the piston moving in a circular path relative to the main body;
wherein the circular path is configured to reside within a plane that is perpendicular to the fascia surface.
wherein the circular path comprises an orbit about a virtual axis, the virtual axis being oriented substantially parallel to the fascia surface;
wherein orbital reciprocation of the piston is configured to reciprocate each attachment along the fascia surface with bidirectional excursions;
each orbiting attachment configured to be continuously expanding and contracting its distance from the piston rocker; and
each orbiting attachment having a first portion removably coupled to the piston and having at least one contact portion for making oscillating contact with the fascia surface.

2. The plurality of orbiting attachments of claim 1 including an attachment having a first portion for removably coupling to the circular path of the orbitally reciprocating piston and one distal end extending therefrom, wherein the one distal end has a contact portion configured in the shape of a partial sphere, and wherein the centroid of the sphere orbits about its own circular path having a virtual axis at the center of its circular path.

3. The plurality of orbiting attachments of claim 1 including an attachment having a first portion for removably coupling to the circular path of the orbitally reciprocating piston and one distal end extending therefrom, the distal end having a contact portion that comprises a roller having an axle, and wherein the axle orbits about its own circular path having a virtual axis at the center of its circular path.

4. The plurality of orbiting attachments of claim 1 including an attachment having a first portion for removably coupling to the circular path of the orbitally reciprocating piston and two distal ends rigidly extending therefrom, each distal end including a contact portion comprising a roller, wherein each roller axle orbits about its own circular path having its own unique virtual axis.

5. The plurality of orbiting attachments of claim 1 including an attachment having a first portion for removably coupling to the circular path of the orbitally reciprocating piston and two distal ends extending therefrom, each distal end rigidly adjoined to the first portion and each distal end including a contact portion having a spherical shape, wherein the centroid of each spherical contact portion orbits about its own circular path having its own unique virtual axis.

6. The plurality of orbiting attachments of claim 1 including an attachment having a first portion for removably coupling to the circular path of the orbitally reciprocating piston and an axle for supporting a rocker comprising two distal ends, each distal end of the rocker having a contact portion comprising a freely rotating roller, wherein each roller axle orbits about its own circular path having its own unique virtual axis.

7. The massage gun of claim 1 having an attachment including a proximal end removably coupled to the housing and having a distal end extending therefrom, the distal end including a contact portion configured for contacting the fascia surface while supporting the main axis perpendicular to the fascia surface.

8. The attachment of claim 7 wherein the distal end contact portion includes a curvilinear portion for contacting the fascia surface.

9. The attachment of claim 7 wherein the distal end contact portion includes at least one freely rotating roller for contacting the fascia surface.

10. A handheld self-powered percussive massage gun for utilization by a user upon a fascia surface comprising:
a housing including a cavity and a handle extending therefrom, the handle graspable by the user for operating the percussive massage gun with one hand upon the fascia surface, wherein the handle possesses multiple portions where each portion defines an axis different from the other handle portions;
the housing cavity having a main axis configured to be oriented perpendicular to the fascia surface;
a piston orbitally reciprocating within a piston rocker while rotatably attached to an eccentric at a first distal end received within the cavity of the housing;
the piston rocker configured to rotate about an axis which is parallel to the fascia surface;
wherein rotation of the piston rocker is configured to cause an axis of the piston to continuously change its angle with the fascia surface;
the piston having a second distal end configured for coupling one attachment therefrom, the one attachment selected from amongst a plurality of orbiting attachments;
the second distal end of the piston moving in a circular path relative to the main body;
wherein the circular path is configured to reside within a plane that is perpendicular to the fascia surface.
wherein the circular path comprises an orbit about a virtual axis, the virtual axis being oriented substantially parallel to the fascia surface;
wherein orbital reciprocation of the piston is configured to reciprocate each attachment along the fascia surface with bidirectional excursions;
each orbiting attachment configured to be continuously expanding and contracting its distance from the piston rocker; and
each orbiting attachment having a first portion removably coupled to the piston and having at least one contact portion for making oscillating contact with the fascia surface.

11. The plurality of orbiting attachments of claim 10 including an attachment having a first portion for removably coupling to the circular path of the orbitally reciprocating piston and one distal end extending therefrom, wherein the one distal end has a contact portion configured in the shape of a partial sphere, and wherein the centroid of the sphere orbits about its own circular path having a virtual axis at the center of its circular path.

12. The plurality of orbiting attachments of claim 10 including an attachment having a first portion for removably coupling to the circular path of the orbitally reciprocating piston and one distal end extending therefrom, the distal end having a contact portion that comprises a roller having an axle, and wherein the axle orbits about its own circular path having a virtual axis at the center of its circular path.

13. The plurality of orbiting attachments of claim 10 including an attachment having a first portion for removably coupling to the circular path of the orbitally reciprocating piston and two distal ends rigidly extending therefrom, each distal end including a contact portion comprising a roller, wherein each roller axle orbits about its own circular path having its own unique virtual axis.

14. The plurality of orbiting attachments of claim 10 including an attachment having a first portion for removably coupling to the circular path of the orbitally reciprocating piston and two distal ends extending therefrom, each distal end rigidly adjoined to the first portion and each distal end including a contact portion having a spherical shape, wherein the centroid of each spherical contact portion orbits about its own circular path having its own unique virtual axis.

15. The plurality of orbiting attachments of claim 10 including an attachment having a first portion for removably coupling to the circular path of the orbitally reciprocating piston and an axle for supporting a rocker comprising two distal ends, each distal end of the rocker having a contact portion comprising a freely rotating roller, wherein each roller axle orbits about its own circular path having its own unique virtual axis.

16. The massage gun of claim 10 wherein the handle comprises a first handle portion that
defines a first axis, a second handle portion that defines a second axis and a third handle portion that defines a third axis, and wherein the three handle axes intersect within the same plane to form a triangle.

17. The massage gun of claim 16 having a stabilizing attachment that includes a proximal end removably coupled to the housing and having a distal end extending therefrom, the distal end including a contact portion configured for contacting the fascia surface while supporting the main axis perpendicular to the fascia surface.

18. The attachment of claim 17 wherein the distal end contact portion includes a curvilinear portion for contacting the fascia surface.

19. The attachment of claim 17 wherein the distal end contact portion includes at least one freely rotating roller for contacting the fascia surface.
